(19) United States
(12) Patent Application Publication
(10) Pub. No.: US 2020/0349641 A1
(43) Pub. Date: Nov. 5, 2020

(54) SYSTEM AND METHOD FOR DETERMINING CREDIT AND ISSUING A BUSINESS LOAN USING TOKENS AND MACHINE LEARNING

(71) Applicant: MO Tecnologias, LLC, Bogota (CO)

(72) Inventors: Paolo FIDANZA, Bogota (CO); Levi Velazquez MULATO, Bogota (CO); Andres ROSSO, Bogota (CO); Robinson Andres JAQUE PIRABAN, Bogota (CO)

(21) Appl. No.: 16/402,282

(22) Filed: May 3, 2019

(51) Int. Cl. G06Q 40/02; H04L 29/06; G06N 20/00

(52) U.S. Cl. CPC G06Q 40/025; G06N 20/00; H04L 63/10

(57) ABSTRACT

A client computing device transmits a request to link a client bank account and receives from a data provider a public access token and transmits it to a loan issuance server, which in turn, transmits it to the data provider. The loan issuance server receives a private access token and limited identity data regarding a bank account associated with the client. A credit score engine receives public data associated with the client and income and transactional data of the client bank account and applies a machine learning model to create an initial credit score that is indicative of the maximum allowed credit for the client. Based on the credit score, the loan approval server approves a loan to be distributed in an amount up to the maximum allowed credit.

### FIELD OF THE INVENTION

The present invention relates to the field of computing, and more particularly, this invention relates to improved computing techniques for determining credit and making a business loan using tokens and machine learning.

### BACKGROUND OF THE INVENTION

Small businesses often have trouble obtaining quick business loans or cash that may be required for purchasing inventory under short time conditions, marketing campaigns, new employee hiring, or other requirements where cash is needed on a short-term basis, often required almost immediately. Before making a loan to a small business, banks often require long credit history investigations that can take weeks or even months. Thus, financial inclusion into adequate credit and cash acquisition is limited because many small businesses cannot access fast cash independent from their credit history. Some banks will take days and even months to make a small loan when the needs of a small business are much more immediate, and would be repaid in less than a month. Therefore, normal banking channels become problematic and do not meet the small business needs of clients.

### SUMMARY OF THE INVENTION

This summary is provided to introduce a selection of concepts that are further described below in the Detailed Description. This summary is not intended to identify key or essential features of the claimed subject matter, nor is it intended to be used as an aid in limiting the scope of the claimed subject matter.

A system for determining the credit and issuing a business loan to a client comprises a client computing device operated by the client and comprising a communications module, a processor connected to the communications module, and a display connected to the processor. A loan issuance server is in communication with the client computing device. The loan issuance server comprises a server communications module, a server processor connected to the server communications module and a transaction database connected to the server processor and storing data related to a loan issuance program, the processor operative to run the loan issuance program at the loan issuance server.

The processor and communications module at the client computing device are operative to communicate with the loan issuance server and initiate registration with the loan issuance program, and in response to instructions received from the loan issuance program, initiate communications with a financial services data provider and transmit a request to link a bank account associated with the client to the loan issuance server. In response to the request to link the bank account, the client computing device receives from the financial services data provider a public access token and transmits the public access token to the loan issuance server. In response to receiving the public access token, the loan issuance server transmits the public access token to the financial services data provider and receives back therefrom a private access token and limited identity data regarding the bank account associated with the client. The loan issuance server is operative to verify with the client computing device that the client has a business account, and if yes, communicate with the client computing device to complete the registration between the client and loan issuance server. When registration is complete, the loan issuance server transmits the private access token and a request for the remaining income and transactional data of the bank account associated with the client to the financial services data provider and receives back therefrom the remaining income and transactional data of the bank account associated with the client. The server processor and server communications module at the loan issuance server are operative to acquire public data associated with the client from publicly accessible data sources and store the public data within the transaction database.

A credit loan engine is associated with the loan issuance server and configured to receive from the loan issuance server the public data associated with the client and the income and transactional data of the bank account associated with the client, and apply a machine learning model to the public data and the income and transactional data and create an initial credit score that is indicative of the maximum allowed credit for the client. Based on the credit score, the loan approval server approves a loan to be distributed in an amount up to the maximum allowed credit.

The loan approval server after approving a loan to be distributed, may credit the loan amount: 1) at a point of sale for a retail establishment, 2) at check-out on an e-commerce website to finance a purchase, or 3) as a credit deposited at the bank account associated with the client. The income and transactional data of the bank account associated with the client may comprise available income as a sum of client incomes weighted by a confidence of income occurrence, and an indebtedness capacity about the capacity of the client to repay the loan. The income and transactional data of the bank account associated with the client may comprise a credit history, including the payment behavior of the client, current banking information and a history of banking transactions with the client. The public data may comprise behavior variables, identity characteristics, social relationships, and photo attributes.

The server processor may be configured to update the initial credit score based on the payment behavior of the client and a bad-debt prediction model. The transaction database may comprise a database server network comprising an on-demand cloud computing platform. The loan approval may occur in under 100 milliseconds after applying the machine learning model to the public data associated with the client and the income and transactional data of the bank account associated with the client. The server processor at the loan approval server may be configured to store the private access token within the transaction database for future access by the loan issuance server of the bank account associated with the client. The credit engine may be integral within the loan issuance server.

A method for determining the credit and issuing a business loan to a client comprises connecting a client computing device operated by the client to a loan issuance server, the client computing device comprising a communications module, a processor connected to the communications module, and a display connected to the processor, and the loan issuance server comprising a server communications module, a server processor connected to the server communications module and a transaction database connected to the processor and storing a loan issuance program. The method further includes accessing from the client computing device the loan issuance program at the loan issuance server, and initiating registration of the client with the loan application program at the loan issuance server. In response to instructions received from the loan issuance program, initiating communications from the client computing device to a financial services data provider, and transmitting a request to link a bank account associated with the client to the loan issuance server. In response, receiving from the financial services data provider a public access token at the client computing device.

The method further includes transmitting the public access token from the client computing device to the loan issuance server, and in response to receiving the public access token, the loan issuance server transmitting the public access token to the financial services data provider and receiving back therefrom a private access token and limited identity data regarding the bank account associated with the client. The method includes verifying with the client computing device that the client has a business account, and if yes, communicating with the client computing device to complete the registration between the client and loan issuance server.

The method further includes transmitting the private access token and a request for the remaining income and transactional data of the bank account associated with the client to the third party financial services data provider, and receiving from the financial services data provider the remaining income and transactional data of the bank account associated with the client. The server processor and server communications module at the loan issuance server are operative to acquire public data associated with the client from publicly accessible data sources and store the public data within the transaction database.

The method further includes receiving within a credit score engine associated with the loan issuance server the public data associated with the client and the income and transactional data of the bank account associated with the client, and applying at the credit score engine a machine learning model to the public data and the income and transactional data and creating an initial credit score that is indicative of the maximum allowed credit for the client, and based on the credit score, approving at the loan approval server a loan to be distributed in amount up to the maximum allowed credit.

### DESCRIPTION OF THE DRAWINGS

Other objects, features and advantages of the present invention will become apparent from the Detailed Description of the invention which follows, when considered in light of the accompanying drawings in which:

FIG. 1 is a block diagram of the system for determining the credit and issuing a business loan to a client in accordance with a non-limiting example.

FIG. 2 is a block diagram showing basic components functioning in the system of FIG. 1 to arrive at an initial or pre-approved loan amount.

FIG. 3 is a block diagram showing a timeline to compute an initial credit score and pre-approved loan amount and upgraded estimates.

FIG. 4 is a block diagram showing general components that may be used in a machine learning model to estimate the credit score and pre-approved loan amount.

FIG. 5 is a sequence diagram showing different stages for calculating risk and indebtedness.

FIG. 6 is a graph of a learning curve showing the training score and validation score that may be used with the system of FIG. 1.

FIGS. 7A and 7B are flowcharts showing an example method of operation for the system of FIG. 1.

FIG. 8 is a screen shot of the loan issuance program where a client may initiate registration.

FIG. 9 is a screen shot showing initial data entry blocks to apply for a loan using the loan issuance program.

FIG. 10 is a screen shot showing the initial stage in linking a bank account associated with a client.

FIG. 11 is a portion of a screen shot showing data entry blocks for selecting a bank associated with the client.

FIG. 12 is a portion of a screen shot similar to that shown in FIG. 11 and showing data entry blocks for entering an online ID and password for a bank account associated with the client.

FIG. 13 is another screen shot similar that shown in FIGS. 11 and 12 and showing successful linking of the bank account with the loan insurance application.

FIG. 14 is a screen shot showing data entry blocks for creating an account with the loan issuance server having the loan issuance application.

FIG. 15 is a screen shot showing approval of a loan to the client.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

The loan issuance system in accordance with a non-limiting example determines the credit and issues a business loan to a client. It may be used to issue loans to consumers for personal needs and requirements. The loan issuance system has a platform that may combine a machine learning algorithm and may use a cloud-based data architecture to allow the system to access a data stream from the online banking of a user and within milliseconds, seemingly “instantly” to a client, approve the client up to a maximum allowed credit. To calculate the credit, the system may use the banking data in conjunction with public variables, e.g., publicly accessible information that may be obtained during registration or at another time. This instant credit applies both to consumers, but preferably to businesses, and can be delivered as an instant credit at a point-of-sale (retail), instant credit at a checkout (e-commerce) to finance a purchase, or as instant cash as credit deposited on the borrower's bank account. The system enhances computer and processor operation to allow what appears to be an “instantaneous” business loan without requiring extensive credit checks or other typical commercial operations.

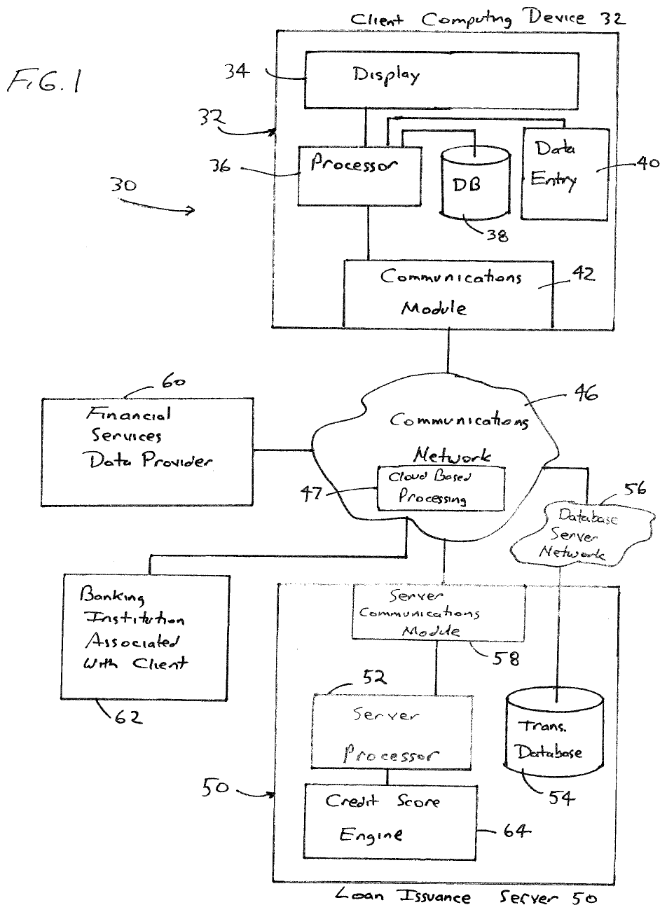

Referring now to FIG. 1, the loan issuance system is illustrated generally at 30 and shows the client computing device 32 that may include a display 34, processor 36 connected to the display, and database 38 connected to the processor. A data entry 40 permits the client or consumer to enter data such as for initial registration with a loan issuance program. The data entry 40 could be a keyboard or graphical user interface on the display 34. A communications module 42 allows the client computing device 32 to communicate via a communications network 46 such as the internet or a wireless communications network to a loan issuance server 50 running the loan issuance program via its server processor 52 that is connected to the server database 54, which may also include a database server network such as a cloud-based database infrastructure 56 or on-demand cloud computing platform. The components of the loan issuance server 50 communicate via a server communications module 58 to the communications network 46. A financial services data provider 60 may connect to the client computing device 32 or loan issuance server 50 and allow communication and retrieving of financial data associated with the bank account of a client at a banking institution 62.

The loan issuance system 30 incorporates a machine learning model that aims to calculate the maximum amount of money to lend a client as a preferred business loan while minimizing risk based on “instant” credit information. The loan issuance server 50 operates in what appears to be almost instantaneously and its server processor 52 may estimate a pre-approved loan amount using the machine learning model with the associated credit risk by obtaining and processing publicly available information about the client and banking or financial data retrieved from a banking institution 62 associated with the client via a third-party financial services data provider 60. This risk measure is then combined with payment capacity forecasting based on the same sources of information, e.g., the banking or financial data and publicly available information credit data may be taken into account.

The machine learning model at the loan issuance server 50 may have two hard constraints. First, the algorithm may work in real-time to deliver decision making information and should balance the risk exposition with the calculated indebtedness capacity. Second, the loan issuance system 50 may recompute a pre-approved amount as an initial loan amount using historical transactions, which improve the accuracy and the confidence of the estimations. The communications network may connect to other computers and servers and provide a cloud-based processing 47. The database server network 56 may connect to different databases and servers and use scalable level object storage.

Other components that are not illustrated may be incorporated into the loan issuance system 30. There may be components associated with a Virtual Private Cloud (VPC), including a REST API and provide interoperability between computer systems on the Internet, allowing systems to access and manipulate textual information. The server processor 52 at the loan issuance server 50 may operate as a controller with other components, including software and/or firmware operative as a local rule engine and an integrated or separate transactional database 54 as illustrated, which may be a sub-component or include a data warehouse that could be incorporated with or separate from the loan issuance server. A machine learning module may be incorporated with the server processor 52 as a controller and operative to have the processor apply a machine learning model to any stored financial data or as illustrated, include the corporate module as a credit score engine 64. The server communications module 58 could operate in a land line based, WiFi or other communications protocol. A local rule engine may interface with a wallet API corresponding to an e-wallet application. It is possible to incorporate components with Amazon Web Services (AWS) and integrate with the server 50, but other types of network systems could be implemented and used besides AWS.

The client may operate their client computing device 32 with an application interface to an Amazon Web Services Web Application Firewall (AWS WAF) to protect web applications from common web exploits and provide security such as a secure locked logo that includes appropriate code and/or hardware components to protect against compromising security breaches and other occurrences or data breaches that consume excessive resources. Similar functions could be provided to the loan issuance server 50.

The loan issuance server 50 may control which data traffic to allow, may block web applications, and may define customizable web security rules. Custom rules for different time frames and applications may be created. If the AWS WAF is used, it may be integrated with an Amazon cloud front that typically includes an Application Load Balancer (ALB). The cloud front may operate as a web service to permit effective distribution of data with low latency and high data transfer speeds. Other types of web service systems may be used.

The Amazon cloud front, if used, may interoperate with a virtual private cloud and provision logically isolated sections of the cloud front to launch various resources in a virtual network that the loan issuance server may define. This may allow control over a virtual network environment, including IP address ranges, subnets, and configurations for route tables and network gateways. A hardware VPN connection may exist between a corporate data center and the use of a virtual private cloud and leverage the AWS cloud front as an extension of a corporate data center. This corporate data center may also include appropriate servers or processes, databases and communications modules that communicate with the loan issuance server.

A Representational State Transfer (REST) Application Programming Interface (API) may interoperate among computer systems on the internet and permit different data requesting systems to access and manipulate representations of web resources using a uniform and predefined set of stateless operations. The AWS may interoperate in one possible example with the AWS Key Management Service (KMS) and manage encryption and may provide key storage, management and auditing to encrypt data across AWS services. An AWS cloud trail may record API calls made on the account and deliver log files, for example, to an “S3” bucket or database as a cloud storage in one example with one or more databases that could be part of a data warehouse operative as a transaction database and provide visibility of the user activity since it records the API calls made on the account of the loan issuance system 30.

The cloud trail, if used, may record information about each API call, including the name of the API, the identity of the caller, the time in different parameters that may be requested, or response elements returned by the service in order to track changes made to AWS resources and determine greater security and identity of users. An AWS Identity and Access Management (IAM) may be used to permit the loan issuance system 30 to control individual and group access in a secure manner and create and manage user identities and grant permissions for those clients to access the different resources. The AWS cloud HSM service may be used to permit compliance with different requirements, including data security using a hardware security module appliance within the cloud. It may help manage cryptographic keys. The AWS CONFIG module, if used, may permit compliance auditing, security analysis, change management, and operational troubleshooting. These different resources may be inventoried with changes and configurations and reviewed relationships. The REST API, if used, may interoperate with the loan rule engine as part of the processor and database.

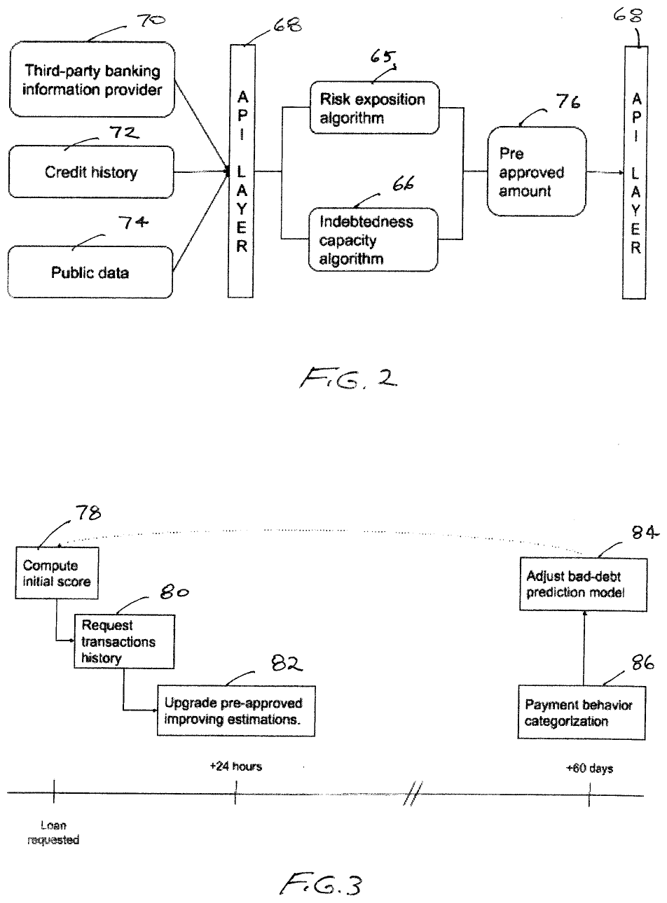

Referring now to FIG. 2, there is illustrated a block diagram of components that function in a high level architecture showing basic algorithm components and information inputs to obtain an initial or pre-approved loan amount. The risk (exposition algorithm) 65 may control the financial risk, and the second algorithm, i.e., an indebtedness capacity algorithm 66, may estimate the amount of money the client can pay back. Information that is input to these algorithms 65,66 via a first Application Programming Interface (API), i.e., application layer 68 may come from different sources, including a third-party banking information provider 70, which in FIG. 1 corresponds to the financial services data provider 60, a credit history 72, and publicly available data 74. Once a pre-approved amount 76 is determined, the application layer 68 provides for further processing and possible user input.

When a client requests a loan, the loan issuance system 30 may access available data and process the data for the initial pre-approval loan amount. The loan issuance server 30 may also gather financial transaction history. The loan issuance system 30 may use this additional information to enhance estimates such as indebtedness capacity and risk factors in order to adjust the previous pre-approved loan amount. This second stage consumes no more than about 24 hours to release an updated pre-approval. The process to compute the pre-approved loan amount for each client may be described so as to disaggregate it in two stages: (1) compute ab initial pre-approval; and (2) upgrade the previous pre-approval. Each stage may involve data-driven models: (1) income forecasting; and (2) bad debt prediction.

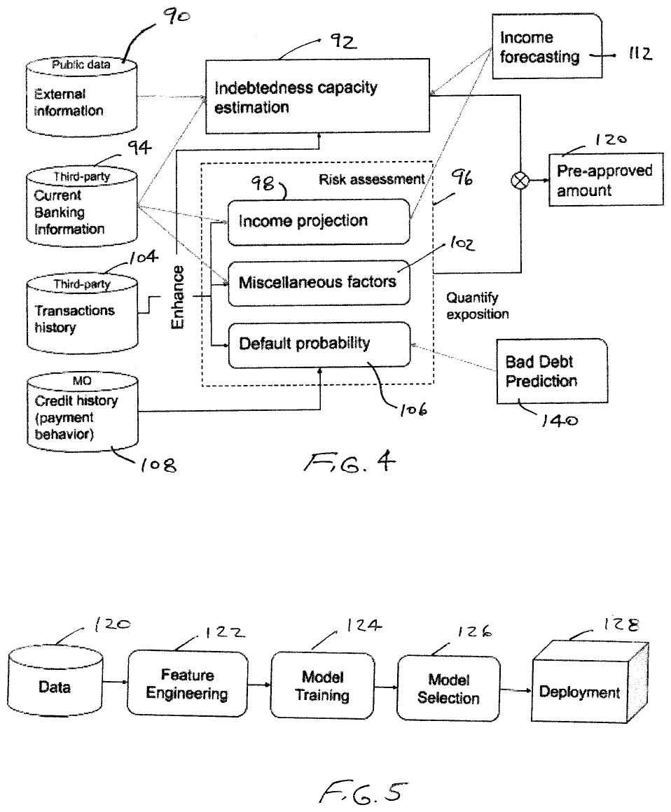

FIG. 3 illustrates a timeline with the different stages to compute the pre-approved amount. When the loan is requested, an initial credit score may be computed 78 using the credit score engine 64 followed by a request for a transactions history of financial data 80. The pre-approved loan amount estimate may be upgraded to improve the estimate 82, for example, in a 24-hour time frame. At about 60 days, a bad debt prediction model may be adjusted 84 and payment behavior categorized 86.

At a first stage, the loan issuance system 30 may use the banking data to forecast client monthly income, discounting the estimate of monthly charges for the client if any credits had been previously taken. The loan issuance system 30 may also estimate indebtedness capacity. It is possible to quantify the exposition according to risk assessment. Bad debt likelihood is a relevant risk factor that the loan issuance system 30 may consider, and the system may calculate that using an online learning approach. For example, when a loan reaches about 60 days, the loan issuance system 30 may label it as a default or no-default and adjust the learning parameters of the machine learning model immediately. Thus, the machine learning model becomes more accurate and available for the next prediction with each labeling.

It is also possible for the loan issuance system 30 to consider as risk factors the income projection that is inferred from forecasting and information with regard to other credit products that belong to the client. Public data also may be used in a parallel prediction model to infer the income and support for the indebtedness capacity estimation. The loan issuance system 30 may also gather the transaction history for each client banking account. Once this financial data is collected, the loan issuance system 30 may use that financial data to improve estimations.

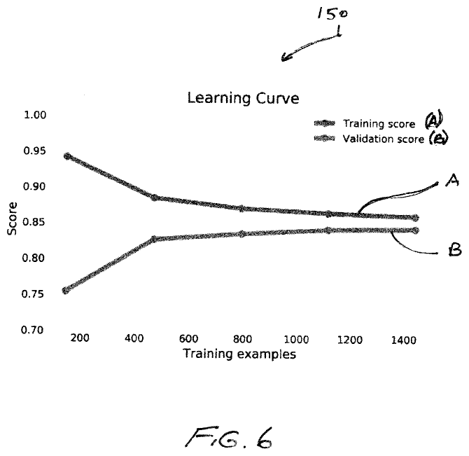

Referring now to FIG. 4, the general model components for operating the loan issuance system 30 and their interoperation are now described. Public data 90 may include external information that is input as part of the indebtedness capacity estimate 92. Current banking information 94 may be used with the risk assessment 96, including the income projection 98 and miscellaneous factors 102 and with the indebtedness capacity estimate 92. Transactions history 104 may be used to enhance the data and estimates, including the probability of default 106. The credit history 108 may be used to aid in determining default probability 106, which may receive information about a bad debt prediction 110. Income forecasting 112 may be used to help determine the indebtedness capacity estimate 92 and income projection 98, and of course, the initial or pre-approved loan amount 120.

Credit history may also encompass a client's past payment history and indebtedness within the loan issuance system 30, or other credit and financial history of the client that the loan issuance system 30 can access. The third-party financial services data provider 60 may send information about a future client's account balance, credit balance, and credit card repayment in an example.

Public data may include behavior variables where a client's behavior may include information about websites visited by the client, product categories purchased by the client, stores visited, ratings on e-commerce websites, the consumer segment the client belongs to, and related, similar data. Identity characteristics may be related to home addresses, neighborhood profiles, length of present residence, education level, employment history and educational level. This information can be found in LinkedIn, Facebook, Google Reviews, and similar items.

Social relationships may reveal a client's social activity and influence within his friends' social network, and also the relationship with people who have had credit scores in the past. The user photo attribute may include other features that can be calculated or inferred by image processing of public photos of the client, e.g., found in social networks and search engines.

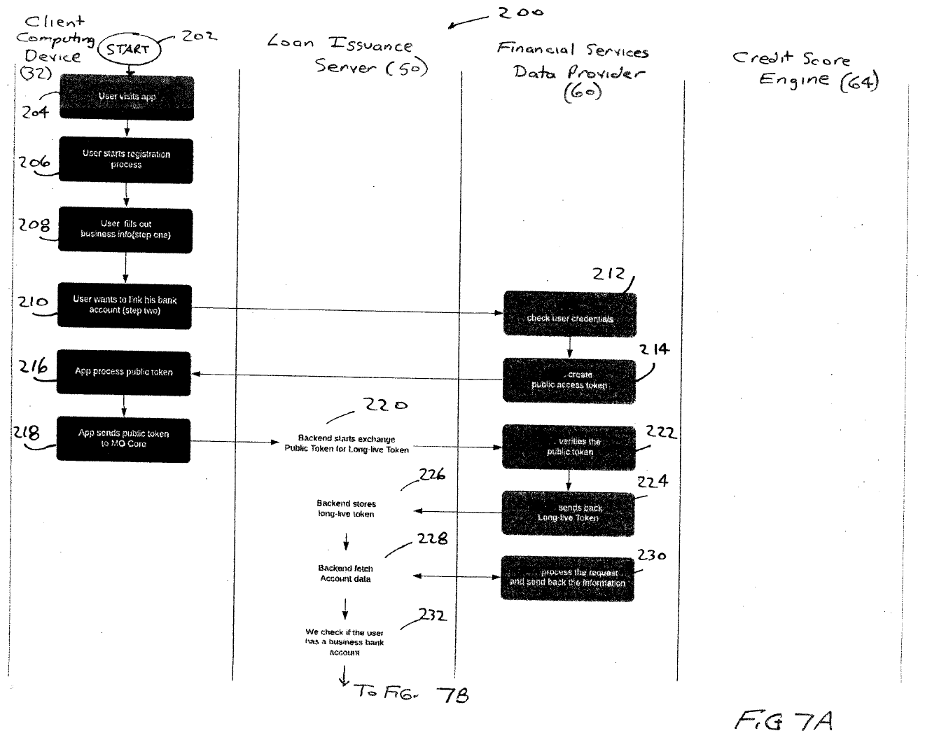

An example sequence or process flow at the loan issuance system 30 to calculate a risk exposition and indebtedness capacity is shown in FIG. 5. The process may start with data 120 and is followed by feature engineering 122, model training 124, model selection 126, and deployment 128.

In a loan issuance process, the feature engineering process may include two main stages, e.g., feature selection and feature extraction. In the first stage of feature selection, the loan issuance system 30 may analyze the given data and select the most relevant features for classification. For this task, the loan issuance system 30 may use standard methods. For example, first, filter methods may apply a statistical measure to assign a scoring to each feature and then obtain a rank. Some examples of some filter methods are the Chi squared test, information gain, and correlation coefficient scores. Wrapper methods may include those methods that consider the selection of a set of features as a search problem, where different combinations are prepared, evaluated and compared to other combinations. An example is the recursive feature elimination algorithm. Embedded methods may be related to how the loan issuance system 30 and a machine learning module as part of the server processor 52 or loan scoring engine 64 may learn which features best contribute to the accuracy of the model while the model is created. A common type of embedded feature selection methods are regularization methods.

In feature extraction, it is possible to further process data to combine features in a meaningful way or to transform them to obtain a better representation. Financial feature extraction may include a model that computes an initial score for each client using banking data retrieved from the third-party financial services data provider 60. It may be assumed in a non-limiting example that loans may be paid in one month. It is possible to compute a pre-approval loan amount based on client income, and the loan issuance system 30 estimates the indebtedness capacity. If income information is not available, the loan issuance system 30 may alternatively compute the pre-approved loan amount based on assets, assuming the account balances for the client.

In a non-limiting example only, the features extracted from third-party banking information or financial services provider may include: (1) available income, which is computed as a sum of client incomes, weighted by the confidence of income occurrence: [available_income]=Σ_i, income_streams_i[confidence]*income_streams_i[monthly_income], and (2) indebtedness_capacity as a prior feature about the capacity of the client to repay.

[indebtedness_capacity]=[available_income]−( 1/12)*Σ[account_balance_current]−[account_balance_available],For all account type=“credit”

If a client has credit products, the risk decreases because it can be assumed that a financial institution had measured risk a priori. There may be model training and model selection, and based on the obtained features, the system may train the classification model. In this step, the system attempts different classification algorithms and selects the one that best fits the business requirements. The system may take into account the following algorithms: 1) Linear Classifiers: Logistic Regression and Naive Bayes Classifier; 2) Support Vector Machines; 3) Decision Trees; 4) Boosted Trees; 5) Random Forest; 6) Neural Networks; and 7) Nearest Neighbor. The selection of the best model may be accomplished in a non-limiting example by evaluating the learning curves and statistical measures for fit. It may be important to take into account which model has a better impact with regard to the business objectives.

Referring now to the graph of FIG. 6, there is illustrated at 150 an example learning curve showing a score on the vertical axis and training examples on the horizontal axis and the merging together of the training score and validation score.

If income information is not available, in another example, the loan issuance system 30 may alternatively compute the pre-approved loan amount based on assets, assuming the account balances for the client.

Income based pre-approved (main)

[credit_line]=[ctrl_exposition]*[indebtedness_capacity]

Assets based pre-approved (alternative)

[credit_line]=[exposition_factor]*Σ[account_balance_current](only for depositary accounts)

Where

[indebtedness_capacity]=[available_income]−( 1/12)*Σ[account_balance_current]-[account_balance_available],For all account type=“credit”

And

[exposition_factor]=[Delta_income]*[has_additional_credit_products]

Predict available income

Available income may be computed as a sum of client incomes, weighted by the confidence of income occurrence:

[available_income]=Σ_i income_streams_i[confidence]*income_streams_i[monthly_income]

Indebtedness capacity Balance
Measure risk

[exposition_factor]=[ctrl_exposition]*Σw_i*[risk_factors]_I

For instance:

[exposition_factor]=[ctrl_exposition]*([trend_factor]+[credit_types_factor])

In this example, it is assumed w_i=1 for all i, hence, the sum could be greater than 1. However, it may be that Σw_i=1.

Where [ctrl_exposition] is a constant in [0,1], it is fixed as a business rule in order to set the maximum exposition.

Risk factors:

Income reduction or increasing. Income

[Delta_Income]=([last_year_income]−[projected_yearly_income])/[last_year_income]

[trend_factro]=1/(1+e\hat{ }(−4[Delta_Income]))

Credit products Balance

If a client has credit products, the risk decreases since the loan issuance system 30 may assume a financial institution had measured risk a priori.

Factors may be related with type of loan. For example, if a credit type of product j is a credit card, the loan approval system 30 can assume beta_j=0.2

[credit_type_factor]=max(Σbeta_j,1)

Feature selection may also be known as variable selection and used to simplify the machine learning model and enhance processing of the computer to be more efficient and facilitate interpretation of data by clients and the loan issuance system 30. This may allow shorter training times to avoid the problems associated with dimensionality and enhanced generalization, for example, by reducing overfitting. With feature selection, the data that contains some features that are either redundant or irrelevant may be removed without incurring much loss of information. This is different from feature extraction that creates new features from functions of the original features, whereas feature selection returns a subset of the features. The loan issuance system 30 may use a combination of search techniques for proposing new feature subsets, along with an evaluation to measure and score different feature subsets. It is possible to test each possible subset of features, finding the one that minimizes the error rate.

The filter methods may use a proxy measure instead of an error rate to score a feature subset. Wrapper methods may use a predictive model to score feature subsets, where a new subset may be used to train a machine learning model that is tested on a hold-outset. The number of mistakes made on that hold-outset may be counted as the error rate of the model to give a score for that subset. The wrapper algorithm may train a new model for each subset. If the number of features are large, not every feature may be used to create the algorithm and only those features that are important may be fed in an example. Thus, a machine learning algorithm may train faster and the complexity reduced and the accuracy increased. Filter techniques may be used as a pre-processing step.

Features may be selected on the basis of their scores and various statistical tests for the correlation with the outcome variable. Pearson's correlation may be used to quantify linear dependents between two continuous variables. The linear discriminate analysis may be used to find a linear combination of features that characterize or separate two or more classes or levels of a categorical variable, while a Chi-squared algorithm may be a statistical test applied to groups of categorical features to evaluate the likelihood of correlation or association between them using their frequency distribution. In a wrapper technique, the subset of features may be used and a model trained using them. Based on the inferences from the previous model that are drawn, it is possible to add or remove features from the subset. This can be a search problem, but computationally expensive.

Some examples of wrapper methods may also include forward selection as an interpretive method or a backward elimination and a recursive feature elimination that aims to find the best performing feature subset. That algorithm may repeatedly create models and keep aside the best or worst performing feature of each iteration. It should be understood there is some difference between filter and wrapper techniques. For example, filter techniques measure the relevance of features by their correlation with dependent variables, while wrapper techniques measure the usefulness of a subset of features by actually training a model on it. Filter techniques tend to be faster compared to wrapper techniques because they do not involve training the models. However, it should be understood that wrapper techniques are computationally expensive as well. The filter techniques may use statistical methods for evaluation of a subset of features, while wrapper techniques may use cross validation. Filter techniques may fail to find the best subset of features in some occasions, but wrapper techniques usually provide the best subset of features. Using a subset of features from the wrapper techniques may make the model more prone to overfitting as compared to using a subset of features from the filter techniques.

As to the information gain ratio, in a decision tree learning technique, the information gain ratio may be the ratio of information gain to intrinsic information. A correlation coefficient may be a numerical measure of some type of correlation, meaning a statistical relationship between two variables such as two columns of a given data set of observations, usually called a sample, or two components of a multi-variate random variable with the known distribution. An example is the Pearson product-moment correlation coefficient. The Chi-squared test may be a statistical hypothesis test.

It should be understood that the recursive feature elimination (RFE) may repeatedly construct a model, for example, a regression model or SVM and choose either the best or worst performing feature such as based on coefficients and setting the feature aside and repeating the process with the rest of the features. This can be applied until all features in the data set are exhausted and features may be ranked according to when they were eliminated. With a linear correlation, each feature may be evaluated independently.

As to the moving window also known as a rolling window in a time series, it is possible to assess the model stability over time. Thus, it is possible to compute parameter estimates over a rolling window of a fixed size through a sample. The rolling estimates may capture the instability. It is possible to use back testing where historical data is initially split into an estimation sample and a prediction sample and the model fit using the estimation sample and H-step ahead predictions made for the prediction sample. Thus, the system as a rolling regression with the rolling time window may have the system conduct regressions over and over with sub-examples of the original full sample. It is possible then to receive a time series of regression coefficients that can be analyzed.

It should also be understood that the system may use a Chi-squared test as a statistical hypothesis test where the sampling distribution of the test statistic is a Chi-squared distribution when the null hypothesis is true. The random decision force may be used as an ensemble learning method or classification, regression and constructs decision trees at training time outputting the class that is the mode of the classes. Mutual information of two random variables may be used as a measure of the mutual dependence between two variables. The analysis of variance (ANOVA) may be used as a collection of statistical models and procedures as a variation among or between groups. The observed variance in a particular variable may be petitioned into components attributable to different sources of variation. There may be some advantages of one or the other of the logistic regression over decision trees. Both are fast methodologies, but logistic regression may work better if there is a single decision boundary not necessarily parallel to the axis and decision trees may be applied to those situations where there is not just one underlying decision boundary, but many.

Based on the features obtained in the financial feature extraction such as available income, indebtedness capacity, and credit products balance risk, a classification model may be trained. Different classification algorithms may be used and the algorithm that may be selected is one that may be considered the best to fit the business requirements that are taken into consideration by the loan issuance system 30. Different algorithms may be selected as noted before, such as using linear classifiers and logistic regression and naive Bayes classifier, support vector machines, decision trees, boosted trees, random forest, neural networks, and nearest neighbor.

Linear classifiers may permit machine learning and statistical classification by using an object's characteristics to identify a class or group to which it belongs. The linear classifier may make the classification decision based on the value of a linear combination of characteristics. Data may include the feature values as described above, and may be presented to the loan issuance server 50 and its server processor 52 in a vector as a feature vector. This will allow document classification also.

It is possible to use degenerative and discriminative models. One type of process is logistic regression that uses the logistic functions to model a binary dependent variable. From a mathematical view, a binary logistic model has a dependent variable with two possible values as represented by an indicator variable, for example, where the two values may be labeled “0” and “1.” With the logistic model, the log rhythm of the odds for the value labeled “1” is a linear combination of one or more predictors, such as independent variables, which can be a binary variable as two classes coded by an indicator variable or a continuous variable as any real value. This may be part of a deep neural network of many layers and the logistic regression may convert the continuous signals in the binary output.

The modeling may use classification rather than regression in the linear sense and calculate the probability that a set of inputs match a label. A logistic regression is often used with deep learning and neural networks and regression may be used, for example, brute force algorithms. It should be understood that logistic regression may be referred to as a binomial classifier and takes input data and no matter the range, compresses it into the space between 1 and 0. No matter how large the input X is, the output Y will not exceed 1, and no matter how low X is, Y cannot fall below 0, thus working as logistic regression that compresses input data into the range between 0 and 1 and forming an S-shaped sigmoidal transform.

As noted before, linear regression may use a linear approach to model the relationship between a scalar response or dependent variable and the other variables as independent variables. It may be a simple linear regression. The linear regression analysis expresses a linear relationship between the input X and the output Y and for every change in X, the Y output may change by the same amount no matter how far along the line. There could be a linear regression or a multiple linear regression.

The naive Bayes classifier is another possible type of linear classifier that may be used for the algorithm at the credit engine 64 and converts evidence into predictions using the probability of one element to predict the probability of another element. As new values occur, better predictions may be formulated. It is possible to use Bayesian networks as graphical models that use Bayesian inference to compute the probability with conditional dependence and causation. Each edge represents a conditional dependency, while each node is a unique variable.

Support-vector machines, also termed support-vector networks, analyze data for classification and regression analysis using supervised learning models and associated learning algorithms. The machine may build a model that assigns new examples to a category as a non-probabilistic binary linear classifier and operates as a representation of examples as points in space that are mapped so that examples of separate categories are divided by a clear gap. New examples may be mapped into the same space and predicted to belong to a category based on which side of the gap they fall. In a support-vector machine, a data point is viewed as a list of P number and it is possible in some instances to separate with a P−1-dimensional hyperplane as a linear classifier. It is also possible to use decision trees as a series of nodes, where a directional graph begins at a base with a single node and extends to many leaf nodes that represent the categories to treat and classify. It operates similar to a flowchart starting at a root node and ending with the decision at the leaves.

A decision tree in conjunction with the loan issuance system 30 may operate as a non-parametric algorithm as opposed to a neural network that processes input data transformed into a tensor via tensor multiplication using a large number of coefficients as parameters. In a decision tree, the sequence of branching operations are based on comparisons of some quantities with the comparisons being assigned the unit computational costs. The branching operations are the tests, thus the algorithm in question could be viewed as a computation of a Boolean function where the input is a series of queries and the output is a final decision. Thus, it is possible to establish a lower balance for computational complexity to be proportional to the largest depth among the decision trees for all the possible inputs. It could be a simple decision, a linear decision tree, on an algebraic decision tree when there is a classification by query computational complexity. There is a classification by a query computational model and it is possible use a deterministic decision tree for the depth where the depth of a tree is the maximum number of queries that can happen before a leaf is reached and a result obtained.

It is possible to use a randomized decision tree to add additional nodes to the tree each controlled by a probability, including a Monte Carlo randomized decision-tree complexity. Others may include a non-deterministic decision tree or a quantum decision tree. Thus, the decision tree may be used for learning as a predictive model from observations represented as the branches to conclusions. The boosted trees could be considered an ensemble method that incrementally builds an ensemble by training each new instance to emphasize training inconsistencies that are previously mis-modeled. Boosted trees are similar to reduce bias and also variance.

Another algorithm that may be used for the model training and model selection as part of the loan issuance system 30 is a random forest algorithm, using many decision trees and could be considered ensembles of decision trees, with each decision tree created by using a subset of the attributes to classify a given population. It may use a supervised classification algorithm and may create many decision trees, and orders their nodes and split randomly. Metadata could be collected with the decision tree containing rules that apply to those features. Neural networks may be used as algorithms that recognize patterns and interpret data and allows clustering and classification. This could be considered a brute force algorithm and operate as a feed forward artificial neural network, similar to non-linear statistical data modeling.

Another possible model training for the loan issuance system 30 includes a nearest neighbor algorithm that may initialize all vertices as unvisited and then select an arbitrary vertex and set it as a current vertex “U” and mark it as visited. The shortest edge connecting the current vertex U and an unvisited vertex V may be determined and the V is set as the current vertex U with V marked as visited. If all the vertices in the domain are visited, then the modeling may terminate, otherwise the shortest edge is again determined. The sequence of the visited vertices is the output of the algorithm.

The decision trees may split a large set of data into smaller classes and analyze where each level of the tree corresponds to a decision. The nodes and leaves may consist of a class of data that are similar to some target variables. There could be nominal (categorical and non-ordered), ordinal (categorical and ordered), and interval values (ordered value that can be averaged). The decision tree may have every leaf as a pure set and a tree may be split further into only pure sets are left as long as subsets do not become too small and give inaccurate results because of idiosyncrasies. One possible algorithm may be the ID3 or iterative dichotomiser 3 as a decision tree constructing algorithm and use entropy as a measure of how certain one can be that an element of a certain set is a certain type.

The other logistic regression and neural networks may include the random force that may use vector-based models that operate on feature vectors of fixed length as an input. Extracted features may be converted into a fixed set of features that may be crafted by domain experts and reflect indicators with a reliable set of features for prediction accuracy. Different iterations of empirical experiments may be used. It is possible to use Recurrent Neural Networks (RNNs) to overcome vector-based methods.

As noted before, decision trees may split a large set of data into smaller classes and analyze where each level of the tree corresponds to a decision. The nodes and leaves may consist of a class of data that are similar to some target variables. There could be nominal (categorical and non-ordered), ordinal (categorical and ordered), and interval values (ordered values that can be averaged). The decision tree may have every leaf as a pure set and a tree may be split further until only pure sets are left as long as subsets do not become too small and give inaccurate results because of idiosyncrasies. One possible algorithm may be the ID3 or Iterative Dichotomiser 3 as a decision tree constructing algorithm that uses Entropy as a measure of how certain one can be that an element of a set is a certain type.

One possible technique could use recurrent neural networks (RNNs) to overcome vector-based methods that can be applied to a series of captured financial and publicly available data that maintain a latent state that is updated with each action. One drawback of the vector-based machine learning similar to logistic regression is the requirement for domain knowledge and data-sign intuition and may include a necessary pre-processing that creates binary input vectors from original input data.

Signals that are encoded in the feature vector are picked up by the prediction model. In contrast to vector-based methods, recurrent neural networks (RNNs) take sequences X=(x₁, . . . , x_{T}) of varying length T directly as inputs. RNNs may be built as connected sequences of computational cells. The cell at step t takes input x_{T} and maintains a hidden state hₜ€R^{d}. This hidden state is computed from the input x_{T} and the cell state at the previous time-step hₜ₋₁ as

hₜ=σ(Wₓxₜ+Wₕhₜ₋₁+b),

where Wₓ and Wₕ are learned weight matrices, b is a learned bias vector and σ is the sigmoid function. It is possible to use a hidden state hₜ that captures data from the input sequence (x₁, . . . , x_{T}) up to a current time-step t. It is possible to prepare over time the data from early inputs. The dimensionality d of the hidden state may be a hyperparameter that is chosen according to the complexity of the temporal dynamics of the scenario.

It is possible to use long short-term memory cells (LSTMs) that help preserve long-term dependencies and help maintain an additional cell state C for long-term memory. It would be possible to calculate any hidden and cell states ht and Ct using a cascade of gating operations:

ft=σ(Wf[ht−1,xt]+bf)

it=σ(Wi[ht−1,xt]+bi)

C\hat{ }t=tan h(Wc[ht−1,xt]+bC)

Ct=ft Ct−1+it C\hat{ }t

ot=σ(Wo[ht−1,xt]+bo)

ht=ot tan h(Ct)

In this cascade, W and b may be learned weight matrices and bias vectors. The final hidden state hT may classify a sequence because hT may be input into a prediction network, which can be a simple linear layer or a sequence of non-linear layers.

There is a training period and the parameters W and b of the computational cells may be used to detect signals in the input sequences in order to help increase the prediction accuracy. Input sequences X are compressed by this process into suitable feature vectors hT. Often the compression process is viewed as feature learning from raw inputs and is the reason why work-intensive human feature engineering may not be required before applying the network. These models are complex and require a long processing time for the learning and predicting stages as compared to vector-based systems. Because there are more architectural choices and hyperparameters to tune, it may be more complex.

The system and method for the loan issuance system 30 as described may also perform a bad debt analysis using the machine learning module as part of the loan issuance server 50, also referred to as the MO server, shown in FIG. 1. Bad debt can increase significantly the revenue loss every year. By using predictive analytic methods, the system utilities can be improved by anticipating and avoiding bad debt losses. There may be key considerations which the system takes advantage of and the system includes methodology to predict and prevent bad debt. The system uses a combination of analytical modeling in conjunction with machine learning techniques. The predictive model exploits patterns found in historical and transactional data of the clients as consumers to identify the risk of a client, i.e., consumer falling into bad debt. The model captures relationships among factors to allow assessment of bad debt risk or the potential of that consumer and associated with a particular set of conditions. This helps guide automatic decision-making in the system so that the system determines when the consumer requires an increase in the maximum allowed credit and the risk involved with increasing the maximum allowed credit. Thresholds can be set of the model outcome.

The machine learning model may construct and implement a bad debt forecast. The problem may be formulated in an example as a supervised learning problem in which the system has input variables as client transaction behavior and a label for each client is the fall into bad debt. The system may process input data and find relationships and have the output data as the labels. Input data may be represented as a numerical vector such as relating to post consumer loan data and the output may be a probability between 0 and 1. This probability represents the probability that a client may fall into bad debt, for example, a value as a threshold greater than 0.6, which may be adjusted. There are various modeling steps including: (1) problem definition; (2) exploratory data analysis; (3) feature ranking; (4) model selection; and (5) model evaluation.

As to the problem definition, it is not always easy to derive a forecast of bad debts because it may be difficult to anticipate the number of variables that impact the ability of a customer as a client or consumer to pay a debt. Typically, the approach is to train a model for each client and then identify an anomaly in credit variables related with default. This approach is very client centric, which makes this methodology difficult to apply to unknown clients or clients that do not have a history of many transactions. The loan issuance system 30 may use a generalized approach to determining the chance of a consumer falling into bad debt independent of the client and the system may explore transactional variables and generalize the patterns that anticipate a bad debt behavior. The loan issuance system 30 may return a bad debt probability that is expected to be continued in order to be sensible to risk severity. This allows a follow-up of the client's risk and can lead to the use of client defined thresholds such as varying from 0.6 as an output threshold to make the system and method more flexible in time.

There are feature vectors that are analyzed. The loan issuance system 30 may have an object to identify the statistically reliable relationships between input data features and a target variable using the machine-learning modeling. Different features may be used and these features may include transactional data from clients in time windows of six months as a non-limiting example and a target variable as a binary outcome that indicates whether a client is moving towards a bad debt region in the next seven days. The features may be extracted from a time series (client behavior measuring variables over time) and these values can help evaluate trends, seasonality or changes that can alert when a client is about to be in bad debt. The transactional variables may be measured over a time window of six months to smooth the input signal since a moving window technique that can be used has seven days of sampling. Based on the obtained smoothed time series, the system may extract the following statistics: mean, standard deviation, median, kurtosis, and skewness. Other variables may be added, including the ratios between time series and combination of different transactional variables.

There are also modeling objectives. One objective is accuracy so that the bad debt prediction method has a good performance in both possible outputs and identifies bad debt clients and identifies good clients. There is also a continuous output objective that has a continuous output and this feature is important in order to follow-up the risk severity path of the client.

The exploratory data analysis may be a next stage. This stage may drive the analysis of the transactional data set to summarize their main characteristics using visual methods and interpretation. Thus, the loan issuance system 30 may make evident what the data can tell the system beyond the formal modeling. Based on this analysis, it is possible to formulate hypotheses that could lead to a precise and accurate experimental approach.

In a feature ranking stage, the loan issuance system 30 may select the final subset of relevant features (variables, predictors) that the system uses. It is relevant for those four reasons: (1) model simplification; (2) low training time; (3) height generalization power; and (4) avoiding the curse of dimensionality.

The loan issuance system 30 may automate the feature ranking to make use of a standard methodology to feed the model with the best predictor variables for the model to forecast the bad debt. According to a recursive feature elimination, the best features for bad debt discrimination from the most correlated to the least correlated are: (1) maximum moving window in kind series; (2) median moving window in time series; (3) skewness moving window in time series; (4) minimum moving window in time series; and (5) incomes/spending ratio.

There now follows an example of the model selection. The loan issuance system 30 may select the model based on the statistical features extracted from the time series and ranked with the previous algorithms. It is possible to test the classification model to predict bad debt. The input variables have a different range based on the nature of the variable to reduce the inter space range variability that is scaled with the variables after an outlier removal. The system has an objective at this stage to test a range of methods and select the method with the best performance based on the defined metric (F1 score).

Features are extracted from a time series (client behavior variable over time) and these values help evaluate trends, seasonality or changes that can alert when a client is about to move into a bad debt situation. In an example, a moving window of seven points as days is used to smooth input signals. In this moving window, the statistics used include: mean, standard deviation, median, kurtosis, and skewness. Other variables may be added and may include the ratios between consignations and commissions and recharges and commissions.

As noted before, it should be understood that the moving window points include the measurements such as the mean, standard deviation, and median in which these are a measure of the central tendency of a value of a data set with the mean (average) as the sum of all data entries divided by the number of entries, and the median as the value that lies in the middle of the data when the data set is ordered. When the data set has an odd number of entries, the median may be the middle data entry, and if the data has an even number of entries, then the median may be obtained by adding the two numbers in the middle and dividing the result by two (2). There are some outliers that are not the greatest and least values but different from the pattern established by the rest of the data and affect the mean, and thus, the median can accommodate as a measure of the central tendency. There are measures of the variation that the standard deviation takes into effect to measure the variability and consistency of the sample or population. The variance and standard deviation will give an idea of how far the data is spread apart. When the data lies close to the mean, then the standard deviation is small, but when the data is spread out over a large range of values, the standard deviation “S” is large and the outliers increase the standard deviation.

By measuring the skewness and kurtosis and using those variables, it is possible to characterize the location and variability of the data set with skewness as a measure of symmetry or the lack of symmetry such that asymmetric data set is the same to the left and right of the center point. Kurtosis measures whether the data are heavy-tailed or light-tailed relative to a normal distribution. Thus, those data sets with high kurtosis tend to have heavy tails or outliers and those data sets with low kurtosis tend to have light tails or lack of outliers. One formula that may be used for skewness may be the Fisher-Pearson coefficient of skewness. It should be understood that the skewness for a normal distribution may be zero (0) and any symmetric data should have a skewness near zero (0). The negative values for skewness indicate data that are skewed left and positive values for skewness indicate data that are skewed right. Thus, skewed left the left tail is long relative to the right tail.

The probability as noted before for a client being in a “bad debt” state or not may be computed through a logistic regression model that may use a regression analysis to conduct when a dependent variable is dichotomous (binary). In an example, it is a predictive analysis and describes data and explains the relationship between one dependent binary variable and one or more nominal, ordinal, interval, or ratio-level independent variables. Also, the regression models may be defined such that the dependent variable is categorical and the algorithm may use the binary dependent variable where the output can take two values “0” and “1” that represent the outcomes. Thus, it is possible to indicate that the presence of a risk factor increases the odds of a given outcome by a specific factor as a direct probability model.

With supervised learning, the loan issuance system 30 operates with machine learning and a function that maps an input to an output based on example input-output pairs and infers a function from labeled training data as a set of training examples. Each example may be a pair as an input object such as a vector and a desired output value as a supervisory signal. The training data may be analyzed and an inferred function produced, which can be used for mapping new examples. Generally, the training examples may be determined and the type of data to be used as a training set may be determined and the training set gathered. The input feature representation of a learned function may be determined and the structure of the learned function in corresponding learning algorithm.

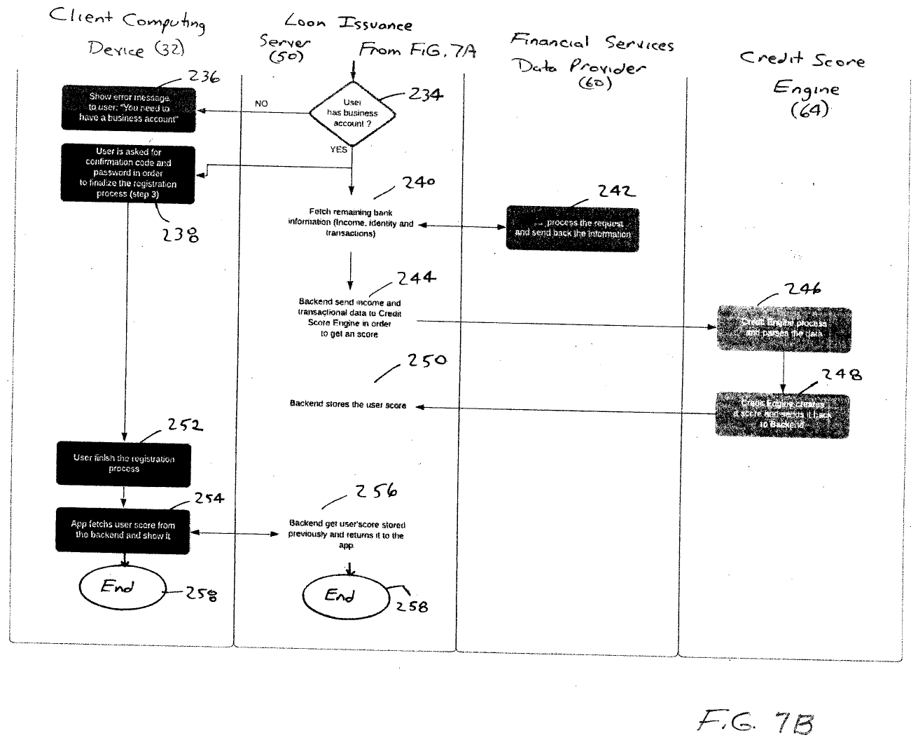

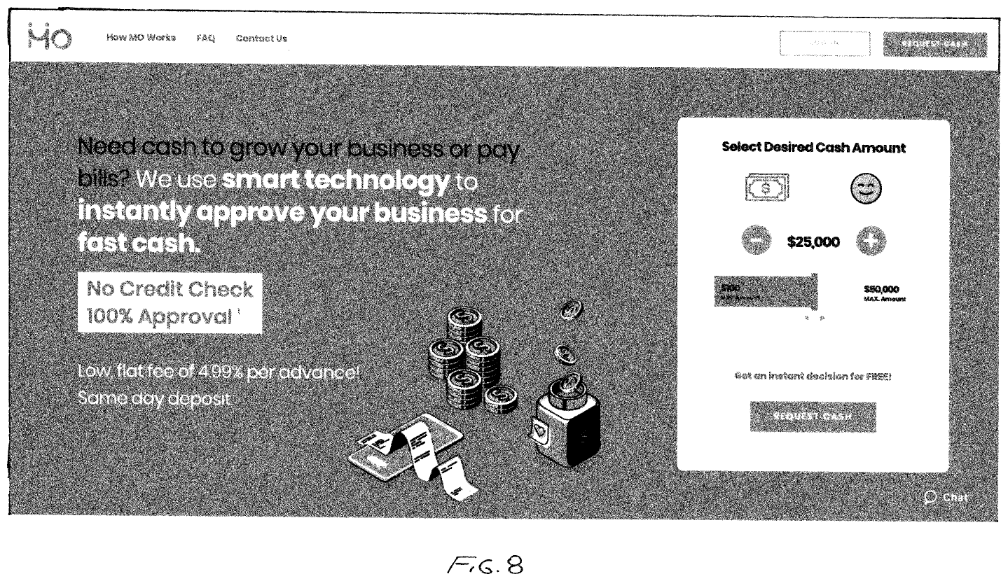

Referring now to FIGS. 7A and 7B, there is illustrated at 200 a detailed flowchart showing the sequence of operation of the loan issuance system 30 shown in FIG. 1 as a non-limiting example. The flow sequence can be read in conjunction with the client computing device 32, loan issuance server 50, financial services data provider 60, and credit score engine 64 that may be part of the server processor 52 in an example. The process starts (Block 202) and a potential client as a user will access the loan issuance server 50 via their client computing device 32, such as a personal computer, laptop, pad device, phone, or other device, and establish contact or “visit” the loan insurance server 50 and access the loan issuance program as an Application Programming Interface (API) and bring a page from the loan issuance program onto a user interface, for example, at the display 34 at the client computing device 32, e.g., the personal computer, laptop, phone, pad device, or other client computing device at the front end (Block 204). The client will begin the registration process (Block 206) and enter data via the user interface on the display 34 or perhaps via the data entry 40, which may include entering the business information, i.e., step one (Block 208).

The client will desire to link his bank account information as a second step (Block 210) and connect to the financial services data provider 60 via the loan issuance server 50 and connect to their bank account at the banking institution 62. The financial services data provider 60 will check the client's credentials (Block 212). Once the client's credentials are verified, the financial services data provider 60 will create a public access token (Block 214), which is then transmitted back to the client computing device 32. The client still has access to the loan issuance application and processes the public access token (Block 216), and via the loan issuance program, the client transmits the public access token to the loan issuance server 50 (Block 218). At the loan issuance server 50, the back end software of the loan issuance program will begin the exchange of the public access token for a new long-life private token (Block 220) and transmit data to the financial services data provider 60, which then verifies the public access token (Block 222) and calculates and processes a long-life private token and sends the private access token back to the loan issuance server 50 (Block 224), where the back end software stores the long-life private access token in the server database 54 at the loan issuance server 50 or other location (Block 226).

The back end software of the loan issuance server 50 is in communication with the financial services data provider 60 and sends a request to the data provider to retrieve account data of the client (Block 228). The financial services data provider 60 processes the request and sends back information about the client account at the banking institution (Block 230). The loan issuance server 50 will check if the client has a business bank account (Block 232) and based upon a “yes” or “no” decision (Block 234), two paths are possible. If the client does not have a business bank account, an error message is shown to the client that they need to obtain a business account (Block 236). If there is a business account, then the client is asked for a confirmation code and password in order to finalize the registration process as a third step (Block 238). The loan issuance server 50 is in communication with the financial services data provider 60 and sends a request to retrieve the remaining bank information such as income, identity and transactions (Block 240).

The financial services data provider 60 processes the request for the back information, contacts the banking institution to which the client has an account and retrieves the bank information associated with the client and sends it back to the loan issuance server 50 (Block 242). The loan issuance server 50 retrieves the remaining bank information such as the income, identity and transactions via the financial services data provider 60 that had processed the request and sends that data back after retrieving it from the client's financial institution or bank. The loan issuance server 50 will forward retrieved income and transactional data to the credit score engine 64 to obtain a score (Block 244).

The credit score engine 64 may be integral to the loan issuance server 50 or a separate computing device and it will process the retrieved financial data (Block 246) in order to obtain a client credit score (Block 248). The credit engine 64 after processing and parsing the financial data and creating a score will send the score back to the back end processing of the loan issuance server 50, which stores the client credit score (Block 250). At this time, the client at the client computing device 32 has finished the registration process (Block 252), and working via the interface to the loan issuance program at the client computing device 32, the client will retrieve the score from the back end and display it (Block 254) on the display 34. The loan issuance server 50 had obtained the client's score that had been stored previously and returns it to the client computing device 32 (Block 256). The process ends (Block 258).

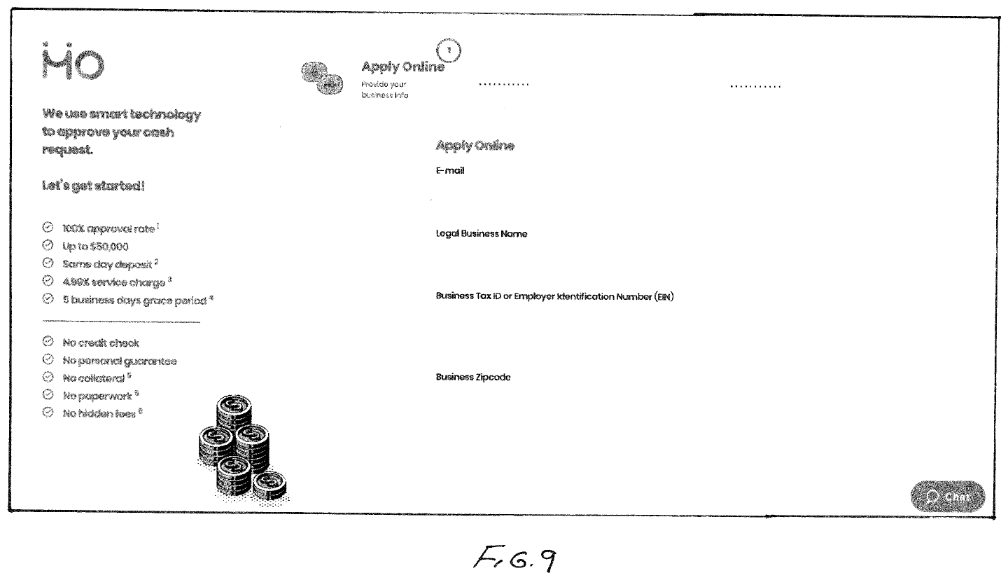

Referring now to FIGS. 8-15, there are illustrated screen shots of examples for process steps that are described generally in FIGS. 7A and 7B. The potential client makes initial contact with the loan insurance server 50 and accesses the loan issuance program. A web page may be displayed as shown in FIG. 8 discussing the loan issuance program with a potential log-in block in case a client is already registered and requesting cash. Some information is illustrated such as no credit check and a low, flat fee of 4.99% per advance and a same day deposit. The footnotes illustrate that there could be further clarifications and requirements.

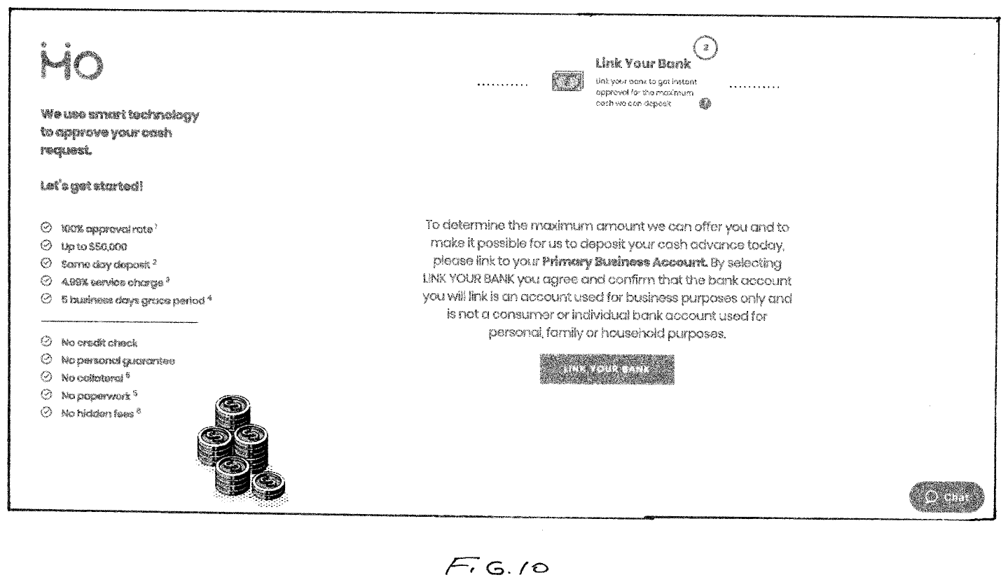

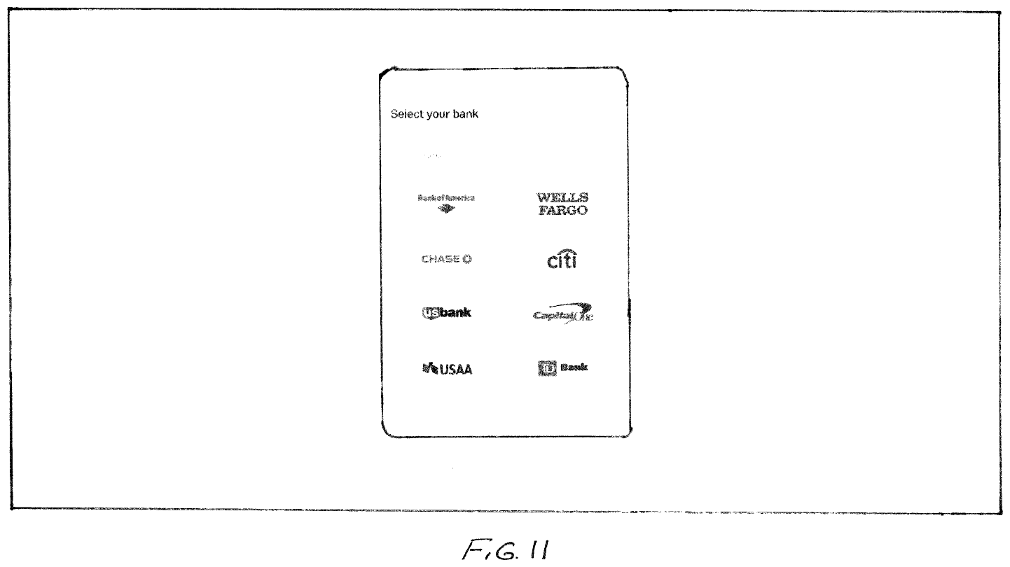

The screen shot in FIG. 9 illustrates the data that may be entered, such as applying on line and some of the benefits, such as up to a $50,000 loan in some cases and no credit check or personal guarantee and no collateral paperwork or hidden fees. The screen shot in FIG. 10 shows how the bank may be linked using a financial services data provider, which in an example, could be a third-party system, such as Plaid. Links may be made to a primary business account.

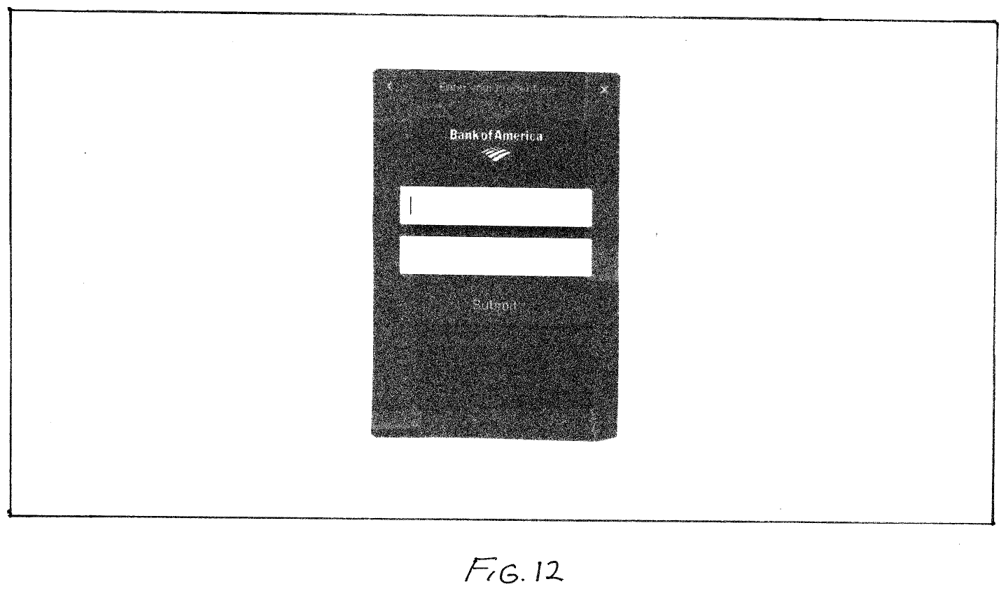

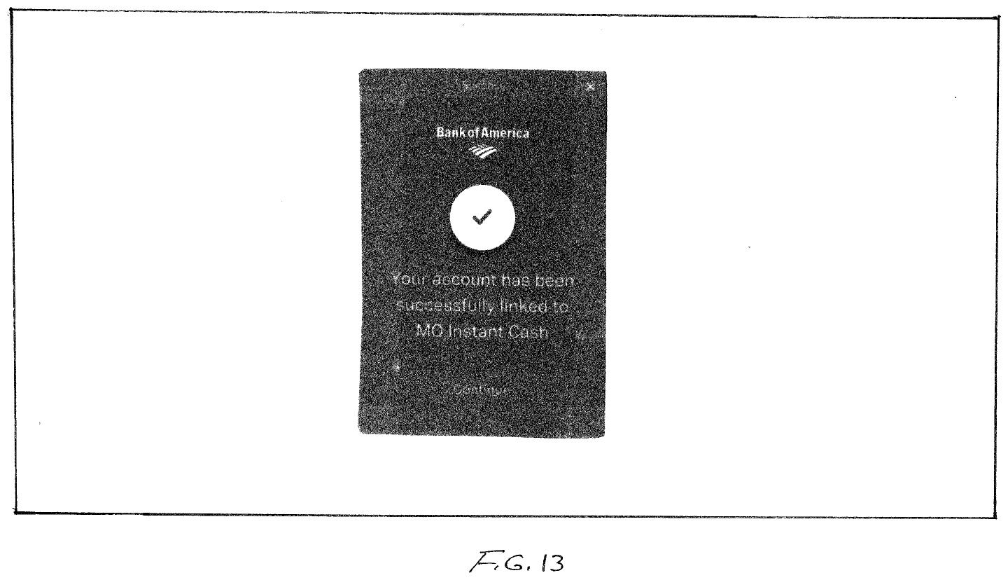

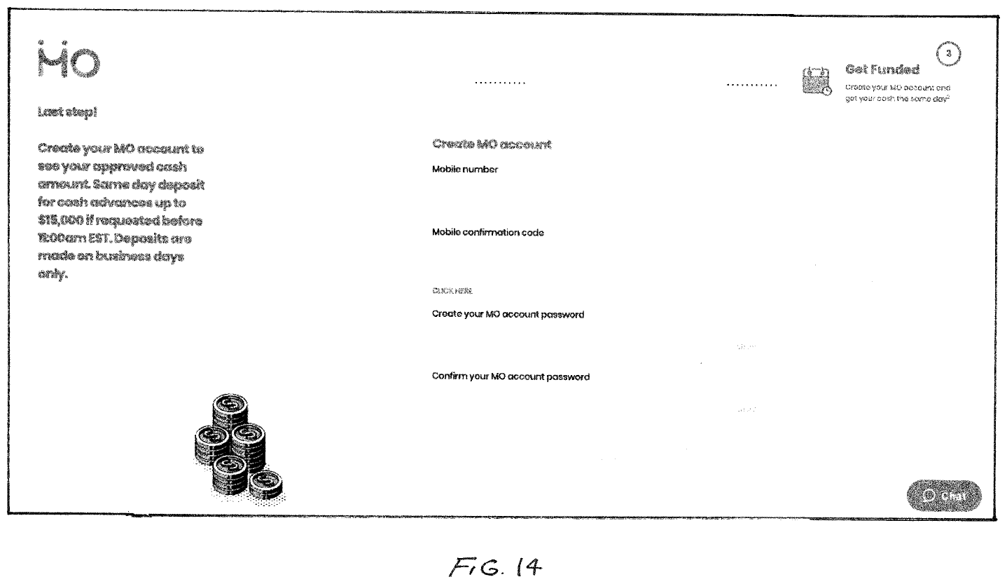

The different banks that could be selected are shown in the example screen shot of FIG. 11, which shows the data entry box and examples of which banks could be selected, but with the balance of the screen shot not illustrated for purposes of simplifying explanation. In the screen shot example of FIG. 12, the Bank of America example is illustrated. After entering the online ID and password, FIG. 13 illustrates an example screen shot showing how the account has been successfully linked to the instant cash program as part of the loan issuance system 30.

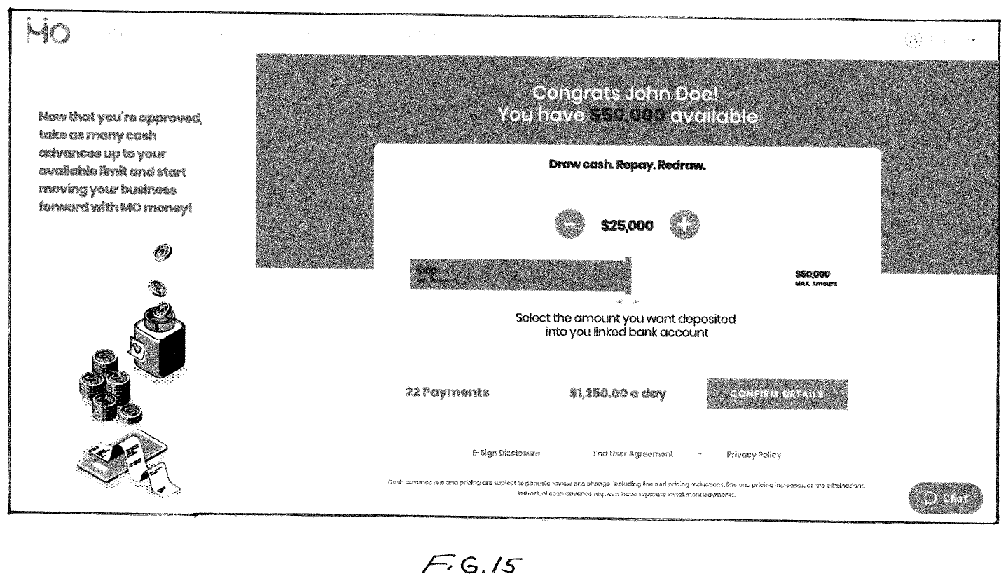

The screen shot in FIG. 14 illustrates that when the bank account for the client has been successfully linked, the account is established, known as the MO account, referring to the loan issuance system 30. In FIG. 15, the screen shot illustrates in this example that the maximum credit of $50,000 is available, and it is possible for the client to choose the amount they want deposited to the linked bank account, and how the 22 payments as $1,250 per day corresponds to the selected $25,000.

The financial services data provider 60 may operate as a third party technology platform that enables the loan issuance program provided by the loan issuance system 30 to connect with a client's bank account. The data provider 60 may operate with the machine learning algorithm and cloud based data architecture, which includes the server database 54 and may connect to a cloud-based database infrastructure 56 to allow the loan issuance system 30 to access the data stream from the online banking of a client and within milliseconds, which seemingly is “instantly” to the client, approve the client for a maximum credit loan amount. The banking data is used in conjunction with public variables such as the publicly accessible data to calculate the credit. This instant credit may apply to both consumers and businesses as clients and can be delivered as instant credit at a point-of-sale (retail) and instant credit at checkout such as e-commerce to finance a purchase or obtain instant cash to obtain the credit deposited on the user or client's borrower bank account.

The financial services data provider 60 may include application software and endpoints for obtaining the data. To retrieve the bank account information, it is possible to expose the Application Program Interface (API) that allows the loan issuance system 30 to obtain that data as soon as the client authenticates with their bank by entering appropriate data at the client computing device 32. Different endpoints may be used such as authentication documents end point to obtain the client's bank account balance and ACH (Automated Clearing House) data that contains the client bank account details in order to make a transfer. A transaction documents endpoint may be used to obtain the last 30 days of transactions from the user. After 200 seconds, it may be possible to retrieve up to two years of financial transaction data. An identity endpoint may be used for obtaining personal information attached to the client bank accounts such as phone numbers, email, and billing addresses. An income endpoint may be used to obtain income as recurrent credits from the bank accounts associated with the client.

A balance endpoint may obtain real-time balance checks and an asset endpoint may provide asset validation. The different products and endpoints may be accessed via a single integrated point. Other information in a transaction endpoint may return data elements, including the current and available balance in the name of the client's bank account, the pending status of transactions, geo-coordinates of a transaction location, the categorization of different transactions, and a statistical confidence score for category and location. Usually transaction data is pulled multiple times per day and notifications may be made. The authentication may authenticate accounts for ACH and eliminate the requirement for clients to enter account and routing numbers or deal with micro-deposits.

A public key or token may be used to initialize a link connection and identify items that can be created or updated. An access token in one example may be considered a rotatable token unique to a single item and used to access data for that item, while a public access token is a short life token that is exchanged for an access token or used to initialize a link in an update mode for an item. The financial services data provider may use POST requests to communicate in http response codes to indicate status and errors and responses may come in standard JSON. Private access tokens as long term or long life tokens are in contrast to public access tokens, and with an item ID, are core identifiers to map an end user to their financial institution. The financial services data provider may provide access to thousands of financial institutions, and thus, many different potential clients as both consumers and business clients may use the loan issuance system 30. A drop-in module may be used to provide an authentication flow. A private access token may be stored in a database of the financial services data provider 60.

It is possible to provide a unique identifier associated with the client's actions through a flow sequence and a list of objects can be associated as part of an account with an ID of a selected account and its name and a mask such that the last 4 digits of the selected account may only be shown in the account type. Each log-in a client prompts may require to answer security questions or answer multiple choice questions and provide a one-time pass code. Clients may select a specific client computing device 32 in which to receive a one-time pass code. A client may be prompted to provide credentials for a selected financial institution. It is also possible that the client through the application programming interface on their client computing device 32 may search for their institution or other institutions and select the institution that submitted credentials.

A public access token may be exchanged for a private access token. The public access token is ephemeral and expires usually after 30 minutes. The public access token may be invalidated once it has been successfully exchanged for a private access token. Any item ID could be stored with an access token. The loan issuance system 30 and the application programming interface, including operation with the financial services data provider 60 may work with many different types of operating systems on computers and communication devices, including the iOS, Android and Windows programs. A query string may be passed as part of a web view integration rather than using a client-side Java Script call. The http redirects may be used for communication between a web view and the application programming rather than a client-side Java Script call backs. If a browser or mobile device does not received security updates, then usually that type of browser or platform will not be supported.

There are different authentication paths for a user operating on a client computing device 32 to verify authentication numbers such as an instant authentication where the client enters their credentials and are authenticated immediately, or an instant match technique where a client enters their credentials, account and routing numbers, and the financial services data provider 60 may match user input and authenticate immediately. It is possible to perform automated micro-deposits where a user enters their credentials, account and routing numbers, and the financial services data provider makes micro-deposits and automatically verifies deposits in 1-2 business days. It is also possible to accomplish same day micro-deposits. Transaction data may be user-authorized and received for credit in depository-type accounts via the transactions endpoint, and the data may be standardized across financial institutions. There may be a unique ID of a transaction corresponding to a transaction ID and the ID of the account in which the transaction occurred such as an account ID. The financial services data provider will collect, parse and clean more recent transactions over 30 to about 240 seconds after an item is added.

It is possible to return a real-time balance for an account with a current balance referring to the total amount of funds in an account. The available balance is the amount of funds available to be withdrawn from an account as determined by the financial or banking institution 62. It should be understood that the available balance may not always equal the current balance less any pending outflows plus any pending inflows. Different account holder information may be obtained via an identity endpoint, including names, emails, phone numbers, and addresses on file with a financial institution. It is also possible to obtain and retrieve information about income, including the annual income and detailed information regarding contributing income string such as a job. This may include income over the past 365 days for a full year's income and income from a previous year interpolated to value before taxes such as the minimum pre-tax salary that assumes a filing status of single with zero dependents or married in another example. Projected yearly income could vary when it is extrapolated over a year based on current, active income streams. This could take an account, for example, if inactive income has not occurred for about more than two cycles.

It is possible to obtain a value or listing of assets and retrieve point-in-time snapshots including account balances, historical transactions and account holder identity information via asset reports. It may be accomplished on a per-user basis. An asset report may be made that is an immutable snapshot of a user's assets. Different days can be selected. Different accounts may appear in an asset report and the loan issuance system 30 may use different accounts and assets as part of its credit engine process. Different formats may be used, including a JSON format. If possible, the financial services data provider 60 will attempt to determine the amount of funds that are available to be withdrawn as determined by the financial institution. The available balance may equal, but not always, the current balance less and pending outflows plus any pending inflows. The total amount of funds in an account may be calculated from the current balance in the balance as determined by the financial services data provider and by subtracting inflows and adding back outflows according to a posted date.

Different audit copies may also be made and provided to both the personnel operating the loan issuance system and the client or user themselves. Fannie Mae information may be taken into consideration. The private access token usually does not expire and is stored in a persistent, secure manner within a database of the financial services data provider 60 as part of their server. It may be rotated over a period of days, weeks or months. A record may be kept of the more recent successful and failed transaction updates. Http response codes may be used for success and failure notifications. It is possible to use authentication web hooks where the financial services data provider may verify an item and send a web hook upon successful verification, 1-2 business days later. If the verification is unsuccessful, it is possible to send an expired web hook. The web hooks may communicate changes to an items. These could be income web hooks or assets web hooks. Different institutions may use one or more products. A different cache system may be used depending on users and type of products.

The loan issuance system 30 may operate with the loan issuance server 50 and promote financial inclusion and aid the credit scoring history and give small businesses the possibility to access fast cash independent from their credit history. The system 30 may operate with different business bank account contacts, which could be changed by the client at almost any time by contacting an operator at the loan issuance system 30 or direct contact via a client computing device 32. It is possible for a client to log-on to their client computing device 32 to determine historical payments, upcoming payments, and preview payments for a new cash request. If a client does not have enough money in their business bank account to make a payment, for example, when a payment is missed due to insufficient funds, the loan issuance server 50 may attempt to withdraw again the following day. A penalty of $10.00 may be added to the final payment for each missed payment and this amount can vary depending on the client, system requirements, and loan amount.

Using the loan issuance system 30, it is not difficult for a potential client to apply for a loan. The loan issuance server 50 may ask via the loan issuance program for basic information about the client's business and then ask the client to securely connect to their business bank account so that the loan issuance system 30 may analyze business performance and automatically approve the client as a business for the maximum cash amount. The loan issuance server 50 has its own financial account, such as First Premier Bank as a non-limiting example, to fund a cash request. It is possible to make a cash request before 11:00 a.m. Eastern Standard Time (EST) during a business day and funds could be deposited into the linked business bank account of the client the same day. Otherwise, the client will probably receive the funds the next business day.

The loan issuance server 50 may process the business banking activity, thus giving a full picture of the client's business in real time without requiring the client to submit paperwork. The credit engine 64 as part of the loan issuance server 50 and its server processor 52 in an example, or a separate computing device in another example, may parse the data it receives and create a score and send it to the back end of the loan issuance server 50, which applies the user's score and return it to the application on the client computing device 32. The client account may remain connected to the loan issuance server 50, not just at the time of application, but also on an ongoing basis so that a client does not have to reapply or reenter their information. The persistent data connectivity between the loan issuance server 50 and the client computing device 32 may also allow a client to be eligible for promotional offers and ensure that the loan issuance system 30 approves the client for the maximum cash amount based on the client's most recent business activities. Information is secure and the bank/data source log-in information is not stored and the loan issuance system 30 has no access to save or change the bank account data. Data is not sold to third parties.

The loan issuance system 30 is advantageous for small businesses that require additional working capital to grow their businesses in numerous ways, from marketing campaigns to purchasing inventory to hiring new employees. There are benefits such as managing the cash flow for a small business. If a business is required to meet payroll, keep the utilities running, or pay their lease or mortgage, the loan issuance system 30 may help cover crucial operating expenses during times when the business experiences a cash flow crunch.

It is possible to bridge payment delays. In many industries, delays in receiving cash for a business' product or service are fairly common. The loan issuance system 30 may help bridge that gap when clients are late in paying their accounts receivable. It is also possible to aid in purchasing inventory when the loan issuance system 30 may be used to restock that client's inventory, purchase new products to sell in the client's business, or help buy additional inventory to fill future orders. Some businesses may rely on the loan issuance system 30 to take advantage of bulk pricing on a large sale and inventory when there is a substantial upfront payment required to take advantage of special pricing. It may be possible to update equipment. For example, if the client is offered a good deal on new equipment that will have long-term benefits for their business, and they do not have the cash to pay for it, the loan issuance system 30 may provide the funds to cover the cost without impacting current cash flow. It is also possible to pay seasonal expenses. This is especially relevant if there is a seasonal industry and it is difficult to restock inventory and hire temporary employees before the busy season.

The loan issuance system 30 may be ideal for covering seasonal expenses as well as boosting pre-season marketing to bring in more sales. It is also possible to cover seasonal shortfalls such as when a small business experiences seasonal slowdowns and operating capital tends to be tight. The loan issuance system 30 may be a valuable tool for managing the cash flow during the off-season, allowing businesses to cover ongoing expenses such as rent, insurance, taxes, utilities, and salaries.

Businesses may look to attract new clients, refresh their brand, or increase their online presence and may use the loan issuance system 30 to launch a new marketing campaign or expand an existing one. The advertising, event sponsorship, direct marketing campaigns, signage, and other return-on-investment opportunities are common uses of the loan issuance system 30. Cash from the loan issuance system 30 may be used by a business for human resources expenses, such as hiring bonuses, employee events and career fares. If the business requires more room to attract more profits or to remodel and provide a better customer experience, the loan issuance system 30 may fund the growth. Small business owners never know when opportunities may occur and if a good location is found to expand the operation, get an offer to staff up a new company, or suddenly be approached by buying out a competitor, is possible to access the loan issuance system 30 to ensure that the business as a client is in a position to jump to the opportunity before it slips away. The loan issuance system 30 may be an option for bridging the cash flow during tax season or funding property tax payments.

Unexpected expenses may arise and no matter how well small business owners plan, unforeseen problems such as equipment troubles, structural damage from fires or floods, or a sudden shift in the market may leave the business strapped for cash. Because the loan issuance system 30 may be used for any business expense, it can mean the difference between keeping the business up and running or having it shut down. It is also possible to leverage expertise where the business owners use the loan issuance system 30 to access advice and training from outside professionals. This may range from hiring a consultant to help implement a new sales program to working with a software expert to speed up the business processes and lower expenses.

Payment deductions may operate in a different manner depending on the type of client or business, but it can be simplified by automatically withdrawing in one example 22 equal payments from the business bank account. Payments could begin 5 business days after the cash is deposited by the loan issuance server 30. The bank that is associated with the client may be asked to deduct payments during business days only. This would give a little over a month to pay back the debt considering that the bank is asked not to deduct payments during weekends and holidays. It is possible to make an early payment on an exception basis. If the customer service department of the loan issuance system 30 approves a client as a business for early payment, the business may still be responsible to pay the entire 4.99% service charge. Arrangements may be made with a representative of the loan issuance system 30.

There is no cost for a business to apply and applying for a loan does not negatively impact the credit score of the business. Different businesses are eligible to request cash through the loan issuance system 30. Approval may require in an example verification of the business information, e.g., the business bank account, and a minimum sale of $1,000 each month for the past three months, as another non-limiting example. Certain verification information may be required from a client such as the tax ID or the EIN, business ZIP code, business bank account, email, or a phone number associated with the business bank account. Considering that the loan issuance system 30 may approve a client as a business for a cash request based on their business performance, it may be recommended to reapply only after the business has experienced positive sales growth.

It is possible to increase the chances of a small business qualifying because the loan issuance system 30 looks at the business' financial performance to determine the maximum cash the business may request. The more sales that the business is able to show, the better chance the business has of qualifying. The business may link the business bank account that contains the majority of the sales transactions to improve any likelihood of qualification. Unlike many other funding companies, the loan issuance system 30 may view the business banking activity to ensure that the maximum cash approval decision is made.

During the client application process, the loan issuance server 50 may be in communication with the client computing device 32 and ask the client or user to link their business bank account, which the loan issuance server 50 will use as the primary business account. Usually, the payment account is the account that the loan issuance system 30 may deposit for the cash request and deduct payments.

The payment amount may be determined using a daily amount deducted based on the requested cash amount plus a one-time 4.99% service charge, divided by 22 payments. Payments may begin 5 business days after the loan issuance system deposits the client's cash request. The bank may be asked to deduct payments during business days only. A one-time 4.99% service charge shall be added to the cash request amounts to cover money transferring and order processing fees.

The financial services data provider 60 may be used to connect to the client's bank account in a secure manner. A service provider, such as Plaid, may be used as noted before or similar application. The application and approval process via the loan issuance system 30 may take only a few minutes in some examples. The credit engine 64 may be used to review the financial performance of the business and with the specific algorithms as described above and their methodology, may determine a client credit score and based upon that information, and other information, share the maximum cash amount it is able to provide. If a client owns multiple businesses, the client may open multiple accounts with the loan issuance system 30 as long as each business has its own unique business bank account. It is usually not possible to link the same business bank account to multiple loan issuance system accounts. Log-in credentials do not have to be stored at the loan issuance server 50, but only an account connection maintained via the financial services data provider 60 in one example.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A system for determining the credit and issuing a business loan to a client, comprising:
a client computing device operated by the client and comprising a communications module, a processor connected to the communications module, and a display connected to the processor;
a loan issuance server in communication with the client computing device, said loan issuance server comprising a server communications module, a server processor connected to said server communications module and a transaction database connected to said server processor and storing data related to a loan issuance program, said processor operative to run the loan issuance program at the loan issuance server;
wherein said processor and communications module at said client computing device are operative to communicate with said loan issuance server and initiate registration with the loan issuance program, and in response to instructions received from the loan application program, initiate communications with a financial services data provider and transmit a request to link a bank account associated with the client to the loan issuance server, and in response to the request to link the bank account, receive from the financial services data provider a public access token, and transmit the public access token to the loan issuance server;
wherein in response to receiving the public access token, said loan issuance server transmits the public access token to the financial services data provider and receives back therefrom a private access token and limited identity data regarding the bank account associated with the client, said loan issuance server operative to verify with the client computing device that the client has a business account, and if yes, communicate with the client computing device to complete the registration between the client and loan issuance server, and when registration is complete, transmit the private access token and a request for the remaining income and transactional data of the bank account associated with the client to the third party financial services data provider, and receive back therefrom the remaining income and transactional data of the bank account associated with the client, said server processor and server communications module at the loan issuance server operative to acquire public data associated with the client from publicly accessible data sources and store the public data within the transaction database; and
a credit score engine associated with the loan issuance server and configured to receive from the loan issuance server the public data associated with the client and the income and transactional data of the bank account associated with the client, and apply a machine learning model to the public data and the income and transactional data and create an initial credit score that is indicative of the maximum allowed credit for the client, and based on the credit score, said loan approval server approves a loan to be distributed up to an amount of the maximum allowed credit.

2. The system according to claim 1 wherein said loan approval server after approving a loan to be distributed, is configured to credit the loan amount: 1) at a point of sale for a retail establishment, 2) at check-out on an e-commerce website to finance a purchase, or 3) as a credit deposited at the bank account associated with the client.

3. The system according to claim 1 wherein said income and transactional data of the bank account associated with the client comprises available income as a sum of client incomes weighted by a confidence of income occurrence, and an indebtedness capacity about the capacity of the client to repay the loan.

4. The system according to claim 1 wherein said income and transactional data of the bank account associated with the client comprises a credit history, including the payment behavior of the client, current banking information and a history of banking transactions with the client.

5. The system according to claim 1 wherein said public data associated with the client comprises behavior variables, identity characteristics, social relationships, and photo attributes.

6. The system according to claim 1 wherein said server processor is configured to update the initial credit score based on the payment behavior of the client and a bad-debt prediction model.

7. The system according to claim 1 wherein said transaction database further comprises a database server network comprising an on-demand cloud computing platform.

8. The system according to claim 1 wherein said loan approval occurs in under 100 milliseconds after applying the machine learning model to the public data associated with the client and the income and transactional data of the bank account associated with the client.

9. The system according to claim 1 wherein said processor at the loan approval server is configured to store said private access token within the transaction database for future access by the loan issuance server of the bank account associated with the client.

10. The system according to claim 1 wherein said credit engine is integral within said loan issuance server.

11. A method for determining the credit and issuing a business loan to a client, comprising:
connecting a client computing device operated by the client to a loan issuance server, the client computing device comprising a communications module, a processor connected to the communications module, and a display connected to the processor, and the loan issuance server comprising a server communications module, a server processor connected to said server communications module and a transaction database connected to said server processor and storing a loan issuance program;
accessing from the client computing device the loan issuance program at the loan issuance server;
initiating registration of the client with the loan issuance program at the loan issuance server, and in response to instructions received from the loan issuance program, initiating communications from the client computing device to a financial services data provider, transmitting a request to link a bank account associated with the client to the loan issuance server, and receiving from the financial services data provider a public access token at the client computing device;
transmitting the public access token from the client computing device to the loan issuance server;
in response to receiving the public access token, the loan issuance server transmitting the public access token to the financial services data provider and receiving back therefrom a private access token and limited identity data regarding the bank account associated with the client;
verifying with the client computing device that the client has a business account, and if yes, communicating with the client computing device to complete the registration between the client and loan issuance server, and when registration is complete;
transmitting the private access token and a request for the remaining income and transactional data of the bank account associated with the client to the third party financial services data provider;
receiving from the financial services data provider the remaining income and transactional data of the bank account associated with the client, wherein the server processor and server communications module at the loan issuance server is operative to acquire public data associated with the client from publicly accessible data sources and store the public data within the transaction database;
receiving within a credit score engine associated with the loan issuance server the public data associated with the client and the income and transactional data of the bank account associated with the client; and
applying at the credit score engine a machine learning model to the public data and the income and transactional data and creating an initial credit score that is indicative of the maximum allowed credit for the client, and based on the credit score, approving at the loan approval server a loan to be distributed up to the amount of the maximum allowed credit.

12. The method according to claim 11 wherein the loan approval server after approving a loan to be distributed, credits the loan amount: 1) at a point of sale for a retail establishment, 2) at check-out on an e-commerce website to finance a purchase, or 3) as a credit deposited at the bank account associated with the client.

13. The method according to claim 11 wherein the income and transactional data of the bank account associated with the client comprises available income as a sum of client incomes weighted by a confidence of income occurrence, and an indebtedness capacity about the capacity of the client to repay the loan.

14. The method according to claim 11 wherein the income and transactional data of the bank account associated with the client comprises a credit history including the payment behavior of the client, current banking information and a history of banking transactions with the client.

15. The method according to claim 11 wherein the public data comprises behavior variables, identity characteristics, social relationships, and photo attributes.

16. The method according to claim 11 wherein the server processor is configured to update the initial credit score based on the payment behavior of the client and a bad-debt prediction model.

17. The method according to claim 11 wherein the transaction database further comprises a database server network comprising an on-demand cloud computing platform.

18. The method according to claim 11 wherein the loan approval occurs in under 100 milliseconds after applying the machine learning model to the public data associated with the client and the income and transactional data of the bank account associated with the client.

19. The method according to claim 11 wherein the processor at the loan approval server is configured to store the private access token within the transaction database for future access by the loan issuance server of the bank account associated with the client.

20. The method according to claim 11 wherein the credit engine is integral within the loan issuance server.
